(19) United States
(12) Patent Application Publication
(10) Pub. No.: US 2011/0226187 A1
(43) Pub. Date: Sep. 22, 2011

(54) DISPENSER FOR EDIBLE PELLETS FOR ANIMALS

(75) Inventor: Patrick M. Bertsch, Thornton, CO (US)

(73) Assignee: Doskocil Manufacturing Company, Inc., Arlington, TX (US)

(21) Appl. No.: 12/724,784

(22) Filed: Mar. 16, 2010

(51) Int. Cl. A01K 5/00; A01K 29/00

(52) U.S. Cl. 119/61.55

(57) ABSTRACT

An egg-shaped dispenser for edible pellets for animals includes a housing with a first portion lockably attacked to a second portion defining a cavity, openings into the cavity, and an opening control member. The first portion and second portion may be lockably detached to allow for edible animal pellets to be placed within the cavity and/or to allow adjustment of the opening control member. A weight disposed within the dispenser is operable to keep the dispenser vertical unless force is exerted and return the dispenser vertical after the force is exerted. Edible animal pellets contained within the cavity may be dispensed via the openings when the dispenser is moved out of the vertical position. The openings may be of different sizes. The opening control member may be rotated between different positions to adjust the size of one or more openings and may be operable to lock in place in the different positions.

### FIELD OF THE INVENTION

This invention relates generally to animal products, and more specifically to a dispenser for edible pellets for animals.

### BACKGROUND

Dry animal food is typically formed into pellets, i.e. kibble, such as the various shaped nuggets or particles of dog or cat food or treats. Toys for animals may be able to contain and dispense such edible animal pellets. Animal toys that contain and dispense edible animal pellets can serve to control the amount an animal is able to eat, cause the animal to exercise in order to get the food, and/or encourage the animal to play with the toy. Further, pet owners may give their pet such toys in order to enjoy watching the pet play. Hence, there is a need for animal toys that are operable to contain and dispense animal pellets, including the ability to control the amount and type of edible pellets that are dispensed, while having play value for animals.

### SUMMARY

The present disclosure provides an edible animal pellet dispensing apparatus. The apparatus may be egg-shaped or approximately or substantially egg-shaped. The apparatus includes a housing that includes a first housing portion which is lockably attachable to a second housing portion to define a cavity. The housing also includes one or more openings that open into the cavity and an internally and/or externally adjustable opening control member. The first housing portion and second housing portion are lockably detachable to allow for one or more edible animal pellets to be placed within the cavity and/or to allow internal adjustment of the opening control member.

The apparatus includes a weight disposed within the housing that is operable to keep a shared axis of the first housing portion and second housing portion in a vertical position unless force is exerted upon the housing to move the shared axis out of the vertical position. The apparatus may be operable to dispense one or more edible animal pellets contained within the cavity via the one or more openings when force is exerted upon the housing to move the shared axis out of the vertical position. After force has been exerted upon the housing to move the shared axis out of the vertical position, the weight may be operable to return the shared axis back to the vertical position.

One or more of the openings in the housing may be a different size than one or more of the other openings in the housing. The opening control member may be rotated between a number of different positions to block, partially block, or not block one or more of the openings. Thus, the opening control member may be operable to adjust the size of one or more of the openings. In this way, the apparatus may be operable to control the amount or size of edible animal pellets that the apparatus dispenses. The opening control member may be operable to lock in place in one or more of the positions.

It is to be understood that both the foregoing general description and the following detailed description are exemplary and explanatory only and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is an isometric view of an edible animal pellet dispensing apparatus, in accordance with an embodiment of the present disclosure;

FIG. 2 is a front plan view of the edible animal pellet dispensing apparatus of FIG. 1; and

FIG. 3 is a exploded view of the edible animal pellet dispensing apparatus of FIG. 1;

FIG. 4 is a cross-sectional view of the edible animal pellet dispensing apparatus of FIG. 1;

FIG. 5A is a top view of the lower housing member of the edible animal pellet dispensing apparatus of FIG. 1 showing the opening control member in a first position;

FIG. 5B is a side plan view of the lower housing member of the edible animal pellet dispensing apparatus of FIG. 1 showing the opening control member in a first position;

FIG. 6A is a top view of the lower housing member of the edible animal pellet dispensing apparatus of FIG. 1 showing the opening control member in a second position;

FIG. 6B is a side plan view of the lower housing member of the edible animal pellet dispensing apparatus of FIG. 1 showing the opening control member in a second position;

FIG. 7A is a top view of the lower housing member of the edible animal pellet dispensing apparatus of FIG. 1 showing the opening control member in a third position;

FIG. 7B is a side plan view of the lower housing member of the edible animal pellet dispensing apparatus of FIG. 1 showing the opening control member in a third position;

FIG. 8A is a top view of the lower housing member of the edible animal pellet dispensing apparatus of FIG. 1 showing the opening control member in a fourth position;

FIG. 8B is a side plan view of the lower housing member of the edible animal pellet dispensing apparatus of FIG. 1 showing the opening control member in a fourth position;

FIG. 9A is a close-up view of the opening control member of the edible animal pellet dispensing apparatus of FIG. 1; and

FIG. 9B is a internal view of the lower housing member of the edible animal pellet dispensing apparatus of FIG. 1.

### DETAILED DESCRIPTION

The description that follows includes exemplary systems and apparatuses that embody techniques of the present disclosure. However, it is understood that the described disclosure may be practiced without these specific details. Reference will now be made in detail to the subject matter disclosed, which is illustrated in the accompanying drawings.

The present disclosure provides an animal toy that is operable to contain and dispense edible animal pellets. The animal toy is operable to control the amount of edible pellets that are dispensed and is adjustable to control the size of the edible pellets that are dispensed. The animal toy is operable to maintain a vertical position when not acted upon by an animal. When acted upon by an animal (such as a dog, cat, or other animal) to force the animal toy out of the vertical position, the animal toy is operable to dispense edible animal pellets via one or more openings in the animal toy. After acted upon by an animal, the animal toy is operable to return to the vertical position. Hence, the animal toy has play value for animals in addition to being operable to contain and dispense edible animal pellets.

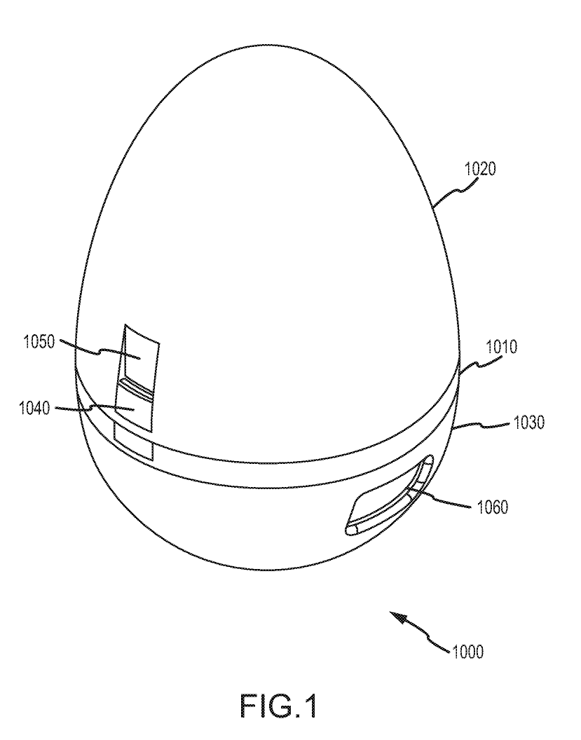

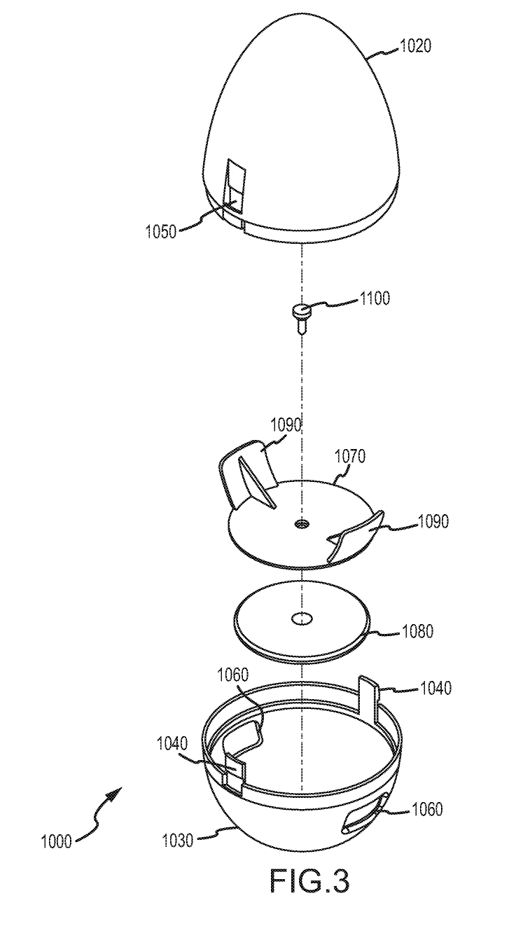

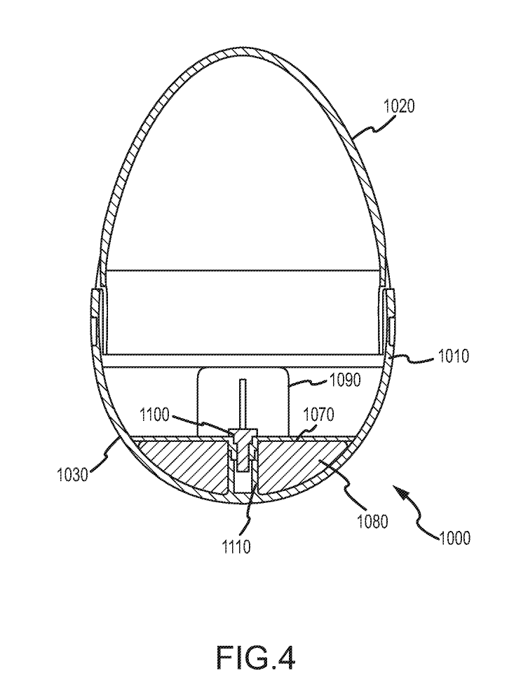

FIG. 1 is an isometric view of an edible animal pellet dispensing apparatus 1000, in accordance with an embodiment of the present disclosure. As illustrated, the edible animal pellet dispensing apparatus 1000 includes a housing 1010. The housing 1010 includes upper housing portion 1020 and lower housing portion 1030. The upper housing portion 1020 and the lower housing portion 1030 may be composed of an opaque material such as plastic. The upper housing portion 1020 and the lower housing portion 1030 are operable to lockably attach to define a cavity within the housing 1010 (best illustrated in FIG. 4) that is operable to contain one or more edible animal pellets. The upper housing portion 1020 is operable to lockably attached to the lower housing portion 1030 utilizing tab members 1040 of the lower housing portion 1030 and slots 1050 of the upper housing portion 1020. The housing 1010 also includes openings 1060 (best illustrated in FIG. 3) that open into the cavity.

As illustrated, the housing 1010 is egg-shaped. However, the housing 1010 may be shapes other than egg-shaped without departing from the scope of the present disclosure. For example, the housing 1010 may be substantially or approximately egg-shaped by varying the heights and widths of the upper housing portion 1020 and/or the lower housing portion 1030. By way of another example, the housing 1010 may even be shapes other than egg-shaped or substantially or approximately egg-shaped. In one implementation of this example, the apex of the upper housing portion 1020 may be the same width as the apex of the lower housing portion 1030 instead of a smaller width as is illustrated. Thus, the housing 1010 would be substantially oval-shaped rather than substantially egg-shaped.

The tab members 1040 (best illustrated in FIG. 3) are flexible and may be pressed inward to allow insertion of the tab members 1040 into the upper housing portion 1030. After insertion, the tab members 1040 are operable to expand and lock into the slots 1050. The upper housing portion 1020 and the lower housing portion 1030 are operable to lockably detach, as illustrated in FIG. 3, by pressing the tab members 1040 inward, such that they are not locked into the slots 1050, and separating the upper housing portion 1020 and the lower housing portion 1030 to remove the tab members 1040 from the upper housing portion 1020.

The upper housing portion 1020 and the lower housing portion 1030 may be lockably detached to allow access to the cavity defined within the housing 1010 by the upper housing portion 1020 and the lower housing portion 1030. The upper housing portion 1020 and the lower housing portion 1030 may be lockably detached to allow one or more edible animal pellets to be placed into the cavity.

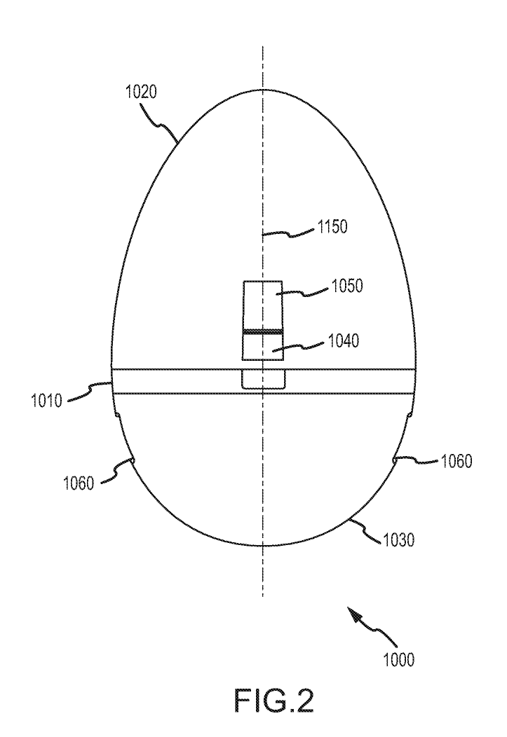

FIG. 2 illustrates a front plan view of the edible animal pellet dispensing apparatus 1000. As illustrated, the openings 1060 are included in the lower housing portion 1030. However, the openings 1060 may be included in the upper housing portion 1020, the lower housing portion 1030, or both the upper housing portion 1020 and the lower housing portion 1030 without departing from the scope of the present disclosure. Additionally, as illustrated the edible animal pellet dispensing apparatus 1000 includes two openings 1060. However, the edible animal pellet dispensing apparatus 1000 may include any number of openings 1060, such as one, three, or four, without departing from the scope of the present disclosure. Further, as illustrated, the openings 1060 are approximately the same size. However, the edible animal pellet dispensing apparatus 1000 may include one or more openings 1060 that are larger than one or more other openings 1060 without departing from the scope of the present disclosure.

The upper housing portion 1020 and the lower housing portion 1030 share a central axis 1150. The edible animal pellet dispensing apparatus 1000 is operable to keep the shared central axis 1150 in a vertical position unless force is exerted upon the housing 1010 utilizing a weight 1080, best illustrated in FIG. 3, disposed within the housing 1010. When force is exerted upon the housing 1010, causing the shared central axis 1150 out of the vertical position, the edible animal pellet dispensing apparatus 1000 may be operable to dispense one or more edible animal pellets contained in the cavity via the openings 1060. After force is exerted upon the housing 1010, causing the shared central axis 1150 out of the vertical position, the edible animal pellet dispensing apparatus 1000 is operable to return the shared central axis 1150 to the vertical position utilizing the weight 1080. The weight 1080 may be composed of a material that is relatively heavy compared to the upper housing portion 1020 and the lower housing portion 1030, such as metal or a high-density acrylic.

FIG. 3 illustrates an exploded view of the edible animal pellet dispensing apparatus 1000. FIG. 4 illustrates a cross-sectional view of the edible animal pellet dispensing apparatus 1000. As illustrated in FIGS. 3 and 4, the weight 1080 is placed within the lower housing portion 1030 by mounting the weight 1080 on a mounting tube member 1110 of the lower housing. Then, an opening control member 1070 is placed over the weight 1080 and rotatably connected to the lower housing portion 1030 by inserting attachment pin 1100 through the opening control member 1070 and the weight 1080 into the mounting tube member 1110. Thus, the opening control member 1070 defines the lower boundary of the cavity defined by the upper housing portion 1020 and the lower housing portion 1030. As illustrated, inserting the attachment pin 1100 into the mounting tube member 1110 causes the mounting tube member 1110 to expand and press on the weight 1080. Thus, the attachment pin 1100 is frictionally held in place. Alternatively, different attachment means may be utilized for the edible animal pellet dispensing apparatus 1000 rather than the attachment pin 1100 and mounting tube member 1100 without departing from the scope of the present disclosure. For example, the weight 1080 may be adhesively fixed to the lower housing portion 1030 and the opening control member 1070 may be rotatably connected to the weight 1080 utilizing a screw.

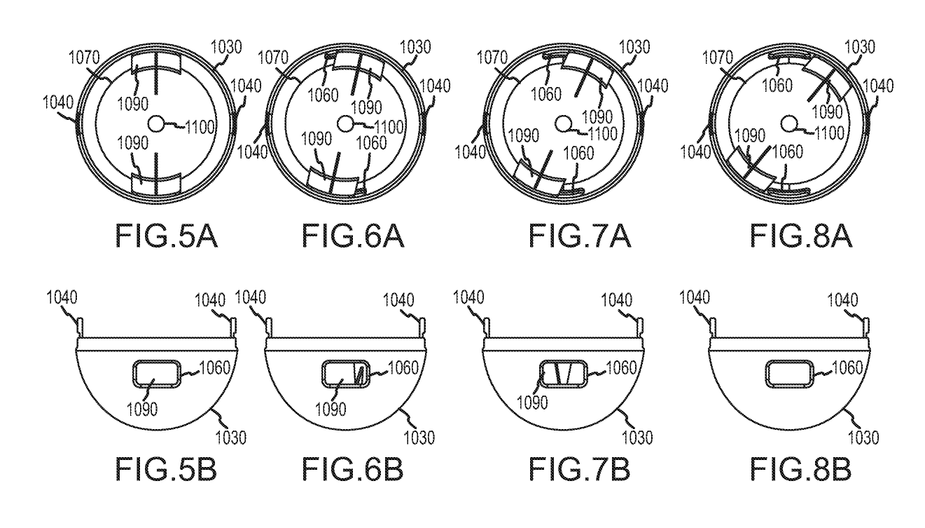

As illustrated in FIGS. 3 and 4, the opening control member 1070 includes a plurality of wing members 1090. The wing members 1090 are flexible and exert pressure against the lower housing portion 1030 from within. As illustrated in FIGS. 5A through 8A, the opening control member 1070 is operable from within the cavity (such as when the upper housing portion 1020 and the lower housing portion 1030 are detached) to rotate between a number of positions. The opening control member 1070 may also be operable to rotate from outside the edible animal pellet dispensing apparatus 1000. In various positions of the opening control member 1070, the wing members 1090 are operable to block, partially block, or not block the openings 1060. By blocking, partially blocking, or not blocking the openings 1060, the wing members 1090 are operable to control whether edible animal pellets are dispensed or the maximum size of edible animal pellets are dispensed.

FIG. 5A illustrates the opening control member 1070 in a first position where the wing members 1090 block the openings 1060. FIG. 5B shows a side plan view of the lower housing member 1030 when the opening control member 1070 is in the first position, illustrating that the opening 1060 is completely blocked. Thus, when the opening control member 1070 is in the first position, the edible animal edible animal pellet dispensing apparatus 1000 is not operable to dispense edible animal pellets regardless whether force is exerted on the edible animal pellet dispensing apparatus 1000 sufficient to cause the shared central axis 1150 to move out of the vertical position. By way of example, a user may rotate the opening control member 1070 to the first position if the user does not wish their animal to be able to cause the edible animal pellet dispensing apparatus 1000 to dispense edible animal pellets.

FIG. 6A illustrates the opening control member 1070 in a second position where the wing members 1090 partially block the openings 1060 such that the majority of the openings 1060 are blocked. FIG. 6B shows a side plan view of the lower housing member 1030 when the opening control member 1070 is in the second position, illustrating that the opening 1060 is partially blocked such that the majority of the opening 1060 is blocked. Thus, when the opening control member 1070 is in the second position, the edible animal edible animal pellet dispensing apparatus 1000 is operable to dispense edible animal pellets upon the exertion of force sufficient to cause the shared central axis 1150 to move out of the vertical position only if the edible animal pellets are smaller than the portion of the openings 1060 that are unblocked.

FIG. 7A illustrates the opening control member 1070 in a third position where the wing members 1090 partially block the openings 1060 such that the majority of the openings 1060 are unblocked. FIG. 7B shows a side plan view of the lower housing member 1030 when the opening control member 1070 is in the third position, illustrating that the opening 1060 is partially blocked such that the majority of the opening 1060 is unblocked. Thus, when the opening control member 1070 is in the third position, the edible animal edible animal pellet dispensing apparatus 1000 is operable to dispense edible animal pellets upon the exertion of force sufficient to cause the shared central axis 1150 to move out of the vertical position only if the edible animal pellets are smaller than the portion of the openings 1060 that are unblocked. However, the edible animal edible animal pellet dispensing apparatus 1000 is operable to dispense larger edible animal pellets when the opening control member 1070 is in the third position than when the opening control member 1070 is in the second position as more of the openings 1060 are unblocked.

FIG. 8A illustrates the opening control member 1070 in a fourth position where the wing members 1090 do not block the openings 1060. FIG. 8B shows a side plan view of the lower housing member 1030 when the opening control member 1070 is in the fourth position, illustrating that the opening 1060 is not blocked. Thus, when the opening control member 1070 is in the fourth position, the edible animal edible animal pellet dispensing apparatus 1000 is operable to dispense edible animal pellets upon the exertion of force sufficient to cause the shared central axis 1150 to move out of the vertical position so long as the edible animal pellets do not exceed the size of the openings 1060. Thus, the edible animal edible animal pellet dispensing apparatus 1000 is operable to dispense larger edible animal pellets when the opening control member 1070 is in the fourth position than when the opening control member 1070 is in the third position or the second position.

As illustrated in FIGS. 5A through 8A, the opening control member 1070 includes two wing members 1090 disposed opposite each other such that the two wing members 1090 are operable to block, partially block, or unblock the openings 1060 at the same time. However, the opening control member 1070 may include any number of wing members 1090 disposed in any arrangement on the opening control member 1070 such that the wing members 1090 are operable to block, partially block, or unblock one or more openings 1060 independent of other openings 1060 without departing from the scope of the present disclosure. In such an arrangement, the opening control member 1070 would be operable to block or partially block one or more openings 1060 while leaving one or more other openings 1060 unblocked. In this way, the opening control member 1070 would be operable to control the amount of edible animal pellets the edible animal edible animal pellet dispensing apparatus 1000 is operable to dispense as well as the size of the edible animal pellets the edible animal edible animal pellet dispensing apparatus 1000 is operable to dispense.

Further, although the opening control member 1070 is illustrated as including wing members 1090 operable to block, partially block, or unblock the openings 1060, the opening control member 1070 may include other means for blocking, partially blocking, or unblocking the openings 1060 without departing from the scope of the present disclosure. For example, the opening control member 1070 may include a ring member that encircles the cavity and is flexible and exerts pressure against the lower housing portion 1030 from within. In this example, the ring member may include a plurality of apertures of varying sized. Thus, the opening control member 1070 is operable in this example to rotate to a number of positions where the ring member is operable to block, partially block, or unblock the openings 1060 according to the position of the plurality of apertures on the ring member.

The opening control member 1070 may be operable lock in place when rotated to one or more positions. By locking in place when rotated to a position, the opening control member 1070 may be operable to remain in that position unless force sufficient to overcome the locking means is exerted upon the opening control member 1070 to rotate it to another position. The opening control member 1070 may be operable lock in place when rotated to a position for ease of adjustment. For example, a user may not have to visually inspect the opening control member 1070 during rotation, but rather may be able to rotate the opening control member 1070 until the opening control member 1070 locks into place in a position. The opening control member 1070 may also be operable lock in place when rotated to a position to prevent the opening control member 1070 from moving out of that position absent user intervention. For example, the opening control member 1070 may not rotate out of a position once locked into that position even if the edible animal edible animal pellet dispensing apparatus 1000 is knocked about by an animal or the animal works a claw into one of the openings 1060 in an attempt to cause the edible animal edible animal pellet dispensing apparatus 1000 to dispense more or any edible animal pellets.

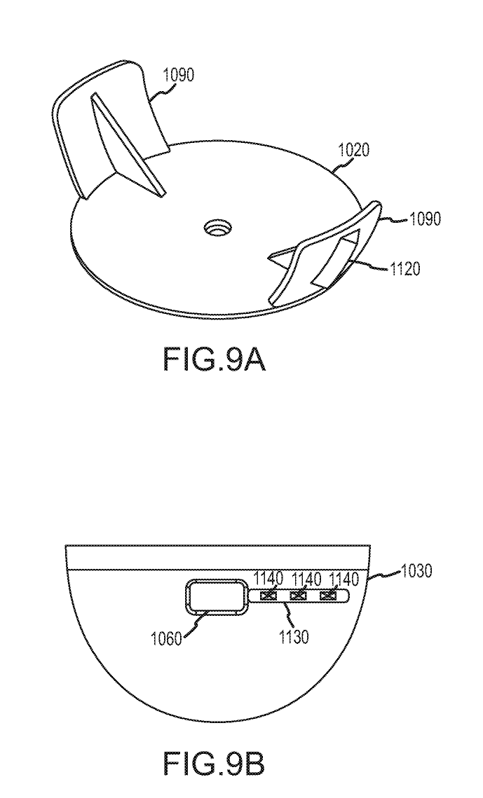

FIG. 9A illustrates a close-up view of the opening control member 1070. As illustrated, the wing member 1090 includes a projecting member 1120 on the surface of the wing member 1090 that exerts pressure against the lower housing portion 1030 from within. FIG. 9B illustrates an interior view of the lower housing member 1130. As illustrated, the interior of the lower housing portion 1030 includes groove 1130 which includes notches 1140. As the opening control member 1070 rotates, the projecting member 1120 travels along the groove 1130. When the projecting member 1120 meets one of the notches 1140, the pressure exerted by the wing members 1090 pushes the projecting member 1120 into the notch 1140, locking the opening control member 1070 in position. To rotate the opening control member 1070 out of a position once locked in place, the opening control member 1070 must be rotated with force sufficient to bend the wing member 1090 away from the lower housing portion 1030 such that the projecting member 1120 leaves the notch 1140 and travels along the groove 1130.

As illustrated, the projecting member 1120 is sloped on each side, resulting in a wedge shape, and each of the notches 1140 is sloped on each side to match the wedge shape of the projecting member. Thus, as the opening control member 1070 is rotated either direction from being locked in a position, the slope of the side of the projecting member 1120 contacts the slope of the side of the notch 1140. This contact forces the wing member 1090 away further away from the lower housing portion 1030 the further that the opening control member 1070 is rotated until the projecting member 1120 leaves the notch 1140 and travels along the groove 1130.

As illustrated, the sides of both the projecting member 1120 and the notches 1140 are sloped. However, one of the sides of the projecting member 1120 or one or more of the notches 1140 may be flat rather than sloped without departing from the scope of the present disclosure. If one of the sides of the projecting member 1120 or one or more of the notches 1140 is flat, the flat side may prevent the opening control member 1070 from rotating in that direction. In such a case, the opening control member 1070 may only be rotated in one direction rather than both directions.

Further, the groove 1130 is illustrated as extending along a portion of the interior of the lower housing portion 1030. However, the groove 1130 may extend all the way around the interior of the lower housing portion 1030.

Additionally, FIGS. 9A and 9B illustrate one projecting member 1120 and three notches 1140. However, any number of projecting members 1120 and notches 1140 may be utilized without departing from the scope of the present disclosure.

Moreover, the projecting member 1120 and notches 1140 described as operable to lock the opening control member 1070 in place in a position are provided as examples. Other means for locking the opening control member 1070 in place in a position may be utilized without departing from the scope of the present disclosure.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. An dispenser for edible pellets for animals, comprising:
an egg-shaped housing comprising:
a first housing portion;
a second housing portion lockably attached to the first housing portion such that the first housing portion and the second housing portion share a center axis; and
a cavity, defined within the egg-shaped housing by the first housing portion and the second housing portion;
wherein the first housing portion and second housing portion are operable to be lockably detached to allow at least one edible animal pellet to be placed into the cavity;
a plurality of openings in the egg-shaped housing into the cavity;
an opening control member, rotatably connected to the egg-shaped housing within the cavity, operable from within the cavity between at least a first position and a second position to adjust a size of at least one of the plurality of openings; and
a weight, disposed within the egg-shaped housing, operable to keep the shared center axis of the egg-shaped housing in a vertical position unless force is exerted on the egg-shaped housing and to return the shared center axis to the vertical position after force has been exerted on the egg-shaped housing;
wherein the at least one of the plurality of openings is operable to allow the at least one edible animal pellet in the cavity to be dispensed when the opening control member is in the first position and force is exerted on the egg-shaped housing moving the shared axis out of the vertical position.

2. The dispenser for edible pellets for animals of claim 1, wherein the at least one of the plurality of openings is not operable to allow the at least one edible animal pellet in the cavity to be dispensed when the opening control member is in the second position.

3. The dispenser for edible pellets for animals of claim 1, wherein the plurality of openings includes a first opening and a second opening and the opening control member is operable in the first position and the second position to adjust a size of the first opening and a size of the second opening.

4. The dispenser for edible pellets for animals of claim 3, wherein the opening control member is operable in the second position to block the first opening and the second opening.

5. The dispenser for edible pellets for animals of claim 3, wherein the opening control member is operable in the second position to block the first opening and partially block the second opening.

6. The dispenser for edible pellets for animals of claim 3, wherein the opening control member is operable to a third position to adjust the size of the first opening but not the size of the second opening.

7. The dispenser for edible pellets for animals of claim 6, wherein the opening control member is operable in the third position to at least partially block the first opening but not the second opening.

8. An edible animal pellet dispensing apparatus, comprising:
a housing comprising:
an upper housing portion including a plurality of slots;
a lower housing portion lockably attached to the first housing portion such that the upper housing portion and the lower housing portion share a center axis, the lower housing portion including a plurality of tab members operable to lockably attach to the upper housing portion by inserting each of the plurality of tab members into a respective one of the plurality of slots of the upper housing; and
a cavity, defined within the housing by the upper housing portion and the lower housing portion;
wherein the first housing portion and second housing portion are operable to be lockably detached, by removing each of the plurality of tab members from the respective one of the plurality of slots, to allow at least one edible pellet to be placed into the cavity;
a plurality of openings in the housing into the cavity;
an opening control member, rotatably connected to the housing within the cavity, operable from within the cavity between at least a first position and a second position to adjust a size of at least one of the plurality of openings; and
a weight, disposed within the housing, operable to keep the shared center axis of the housing in a vertical position unless force is exerted on the housing and to return the shared center axis to the vertical position after force has been exerted on the housing;
wherein the at least one of the plurality of openings is operable to allow the at least one edible pellet in the cavity to be dispensed when the opening control member is in the first position and force is exerted on the housing moving the shared axis out of the vertical position.

9. The edible animal pellet dispensing apparatus of claim 8, wherein the opening control member includes at least one wing member operable to block the at least one of the plurality of openings when the opening control member is in the second position.

10. The edible animal pellet dispensing apparatus of claim 8, wherein the opening control member includes a ring member that encircles the cavity and includes at least one aperture operable to match up with the at least one opening.

11. The edible animal pellet dispensing apparatus of claim 8, wherein the opening control member defines a lower portion of the cavity.

12. The edible animal pellet dispensing apparatus of claim 8, wherein the lower housing portion includes the plurality of openings.

13. The edible animal pellet dispensing apparatus of claim 8, wherein the housing is approximately egg-shaped.

14. The edible animal pellet dispensing apparatus of claim 8, wherein the plurality of openings includes at least a first opening and a second opening wherein the first opening is larger than the second opening.

15. An apparatus for dispensing edible pellets for animals, comprising:
a substantially egg-shaped housing comprising:
a first housing portion;
a second housing portion lockably attached to the first housing portion such that the first housing portion and the second housing portion share a center axis; and
a cavity, defined within the substantially egg-shaped housing by the first housing portion and the second housing portion;
wherein the first housing portion and second housing portion are operable to be lockably detached to allow at least one edible pellet to be placed into the cavity;
a plurality of openings in the substantially egg-shaped housing into the cavity;
an opening control member, rotatably connected to the substantially egg-shaped housing within the cavity, operable from within the cavity between at least an open position, at least one partially open position, and a closed position to adjust a size of at least one of the plurality of openings; and
a weight, disposed within the substantially egg-shaped housing, operable to keep the shared center axis of the substantially egg-shaped housing in a vertical position unless force is exerted on the substantially egg-shaped housing and to return the shared center axis to the vertical position after force has been exerted on the substantially egg-shaped housing; wherein the at least one of the plurality of openings is operable to allow the at least one edible pellet in the cavity to be dispensed when the opening control member is in the open position and force is exerted on the substantially egg-shaped housing moving the shared axis out of the vertical position.

16. The apparatus of claim 15, wherein the at least one partially open position includes a first partially open position and a second partially open position.

17. The apparatus of claim 16, wherein the size of the at least one of the plurality of openings is larger when the opening control member is in the first partially open position than when the opening control member is in the second partially open position.

18. The apparatus of claim 15, wherein the opening control member is operable to lock in place in the first position and the second position.

19. The apparatus of claim 18, wherein the opening control member includes at least one projecting member and the housing includes at least one notch and the opening control member is operable to lock in place by rotating until the at least one projecting member engages the at least one notch.

20. The apparatus of claim 19, wherein the at least one notch is located within a groove in the housing.
